(19) United States
(12) Patent Application Publication
(10) Pub. No.: US 2026/0003043 A1
(43) Pub. Date: Jan. 1, 2026

(54) OPTOELECTRONIC SENSOR FOR A TIME-OF-FLIGHT MEASUREMENT AND METHOD FOR A TIME-OF-FLIGHT MEASUREMENT

(71) Applicants: ams-OSRAM AG, Premstätten (AT); ams-OSRAM Asia Pacific Pte. Ltd., Singapore (SG)

(72) Inventors: Loic PERRUCHOUD, Rechy (CH); Pierre-Yves TALOUD, Annecy Le Vieux (FR); Bastien MOYSSET, Martigny (CH); Pablo TRUJILLO SERRANO, Zürich (CH); Scott LINDNER, Zürich (CH)

(21) Appl. No.: 18/879,897

(22) PCT Filed: May 24, 2023
(86) PCT No.: PCT/EP2023/063926

§ 371 Date: Dec. 30, 2024

(30) Foreign Application Priority Data
Jul. 1, 2022 (DE) 10 2022 116 500.0

(51) Int. Cl. G01S 7/4863; G01S 7/481; G01S 7/4865; G01S 7/497; G01S 17/10

(52) U.S. Cl. CPC G01S 7/4863; G01S 7/4815; G01S 7/4816; G01S 7/4865; G01S 7/497; G01S 17/10

(57) ABSTRACT

An optoelectronic sensor for a time-of-flight (ToF) measurement includes a light projector, a light receiver, a receiver logic, and a processing unit. The light receiver includes a number of macro-pixels. The receiver logic is operable to generate light ToF data for the respective macro-pixels corresponding to a number of time windows. The processing unit selects an initial set of integration times that defines an integration time for each time window and macro-pixel and acquires an initial frame of ToF data by collecting ToF generated from the macro-pixels according to the time windows and integration times defined in the initial set of integration times. The processing unit also computes a metric from the initial frame of ToF data. The metric is indicative of a data quality generated by the respective macro-pixels.

This disclosure relates to an optoelectronic sensor for a time-of-flight measurement and to a method for a time-of-flight measurement. Furthermore, the disclosure relates to an electronic device comprising an optoelectronic sensor for a time-of-flight measurement.

### BACKGROUND

Time-of-flight, or ToF, sensor technology has become increasingly important in both consumer and industry products. ToF sensors are optoelectronic sensors which are capable of measuring the time it takes of emitted light to travel a distance through a medium. Typically, this is the measurement of the time elapsed between the emission of a pulse of light and the reflection off of an external object, and its return to the ToF sensor. Different concepts of ToF sensors have been presented. A direct time-of-flight sensor (dToF) measures the time-of-flight required for laser pulses to leave the sensor and reflect back onto a focal plane array. The integration time denotes the amount of time during which the sensor captures pulses to produce one range measurement.

For technical reasons, it might not be possible to capture the targeted range in one pass. For example, acquiring a histogram per window is an area optimization of the sensor to fit the SPAD area in 3D stacked technology. It allows the dToF sensors to have about the size of the SPAD die. Instead, the targeted range could be divided in multiple windows and each window can be captured sequentially. In this case, each window can use a different integration time. Depending on the scene conditions, it may be necessary to adapt the integration times. Longer integration times will, for example, work better on dark objects or for long ranges while shorter integration times may work better for objects with high reflectivity or at close ranges. It might also be interesting to limit the number of windows to concentrate the integration time budget on the first window. This may reduce the range covered by the sensor. However, to date the art has not come up with a robust and reliable concept for an automatic approach to select the number of windows (i.e., range covered by the sensor) and assign an integration time to each window.

Thus, an object to be achieved is to provide an optoelectronic sensor for a time-of-flight measurement and to provide a method for a time-of-flight measurement that overcome the aforementioned limitations and provide an automatic concept to assign an integration time to a measurement window. A further object is to provide an electronic device comprising such an optoelectronic sensor.

These objectives are achieved with the subject-matter of the independent claims. Further developments and embodiments are described in dependent claims.

### SUMMARY OF THE DISCLOSURE

The following relates to an improved concept in the field of optoelectronic sensors, e.g., to time-of-flight sensors. The improved concept suggests adapting the integration time of a frame as a function of the scene. This could be done with an iterative process that continuously adapts the integration time depending on an environmental factor like the ambient light, or may minimize a number of non-detection events or to optimize the signal-to-noise ratio, SNR.

In at least one embodiment, an optoelectronic sensor for a time-of-flight measurement comprises a light projector, a light receiver, a receiver logic and a processing unit. The light receiver comprises a number of macro-pixels, e.g., one or more pixels grouped together. Particularly, a pixel is formed by a photodiode, for example a single-photon avalanche diode (SPAD), while a macro-pixel is formed by a group of photodiodes.

The receiver logic is operable to generate time-of-flight data for the respective macro-pixels corresponding to a number of time windows. The processing unit is operable to conduct the following steps:

An initial set of integration times is selected and defines an integration time for each time window and macro-pixel. An initial frame of time-of-flight data is acquired by collecting time-of-flight data generated from the macro-pixels according to the time windows and integration times defined in the initial set of integration times. A metric is computed from the initial frame of time-of-flight data, the metric being indicative of a data quality generated by the respective macro-pixels. Optionally, the same integration time can be defined for all macro-pixels.

In an iterative loop the following steps are repeated:

The computed metric is saved as a previous metric. The integration times are updated according to an updated set of integration times that defines updated integration times for the time windows and macro-pixels. An updated frame of time-of-flight data is acquired by collecting time-of-flight data generated from the macro-pixels according to the time windows and integration times defined in the updated set of integration times. The metric is computed from the updated frame of time-of-flight data. The metric from the updated frame of time-of-flight data is compared with at least one saved previous metric. The next integration times can be selected to minimize the metric for the next frame. For example, the gradient between the current metric and the previous metric is used to predict the best integration times for the next frame.

During a time-of flight measurement, the light projector emits laser pulses, which are reflected by objects of a scene in a field of view of the optoelectronic sensor. The reflected laser pulses are detected by the light receiver. From the time interval starting with the time of the emission of the laser pulse and the time of the detection of the reflected laser pulse, a distance of the object reflecting the laser pulses, can be determined. At present, the light receiver comprises particularly, a plurality of light detectors, for example SPADs, for example, grouped to macro-pixels. Thus an image of the scene having a depth resolution can be generated by the time-of flight measurement.

Particularly, the total distance (target range) to be covered by the time-of flight measurement corresponds to a total time window, the total time window being a time interval starting with the time of the emission of the laser pulse and the time of the detection of the laser pulse reflected from an object at the total distance. In order to improve the time-of-flight measurement, the total time window can be divided in several time windows covering different sub-ranges of the total distance. In other words, the time window corresponds to the whole or a part of the total distance.

Acquisition of a frame is the determination of time-of flight data, particularly the measurements of sub-ranges, to cover the total distance.

The integration time denotes the amount of time during which the light receiver captures reflected laser pulses to produce a measurement of one sub-range. Particularly, within the integration time several reflected laser pulses are detected by the light receiver. An integration time for single data points within a given time interval, for example, according to bin widths of a time histogram is not meant with the term “integration time”.

The proposed concept allows to automatically adapt integration times used by the optoelectronic sensors, e.g. a direct time-of-flight sensor, according to a scene to be observed. This can be done with an iterative process that continuously adapts the integration times in function also of environmental factor like the ambient light but also to minimize the number of non-detection events or to optimize the SNR. This improves the depth quality and makes the system more resilient to difficult conditions.

In at least one embodiment, the iterative loop terminates when the comparison meets a convergence criterion. Alternatively, the iterative loop is continuously repeated, i.e. never terminates.

The sensor can be moved in the scene and is thus exposed to changing conditions. In a way, this is similar to the auto-exposure-control algorithm of a color camera that continuously adapts the exposure when the camera is running continuously.

In at least one embodiment, the light projector comprises one or more semiconductor lasers diodes, e.g., vertical cavity surface emitting laser, or VCSEL, diodes. In addition, or alternatively, the light receiver comprises one or more photodiodes, e.g., single-photon avalanche diodes, or SPADs. Particularly, the light projector comprises one or more semiconductor lasers diodes, such as a vertical cavity surface emitting laser or a edge emitting semiconductor laser. Particularly, the light receiver comprises one or more photodiodes, such as single-photon avalanche diodes (SAPDs).

In at least one embodiment, the receiver logic is configurable so as to provide programmable time windows and programmable integration times for said time windows. Thus, time windows and integration times can be set to best meet the requirements of a particular scene.

In at least one embodiment, the light projector is operable to illuminate a field-of-view of a scene or is operable to project a structured pattern into said scene. The proposed concept can, thus, be applied to uniform illumination type and structured light type sensors. The light projector can either be a flood projector that illuminates uniformly the field of view or a dot projector that illuminates the field of view with a structured pattern.

In at least one embodiment, the optoelectronic sensor further comprises an ambient light detector to detect an ambient light level. In the iterative loop, the processing unit is operable to update the integration times depending on the ambient light level. The ambient light detector is optional as the ambient light level may also be estimated from the time-of-flight data. Accounting for ambient light allows to reduce secondary effects such as blooming or ghosting and, thus, may increase depth quality in low light situations. In high ambient light conditions, the number of active windows and therefore the targeted range can be reduced to concentrate the integration time on the first windows and improve the depth quality for the reduced range.

In at least one embodiment, the optoelectronic sensor further comprises a memory to save pre-determined integration tables comprising integration times for time windows. In the iterative loop, the processing unit is operable to update the integration times depending on the integration tables and/or a computational rule, e.g. a gradient. The pre-determined integration tables or computational rule determines how the integration times are updated for the time windows during the iterative process. This way, the iterative process may not involve expensive computational power.

In at least one embodiment, an electronic device comprises a host system and at least one optoelectronic sensor according to one of the aspects discussed above. The host system comprises a mobile device, a computer, a vehicle, a 3D camera, a headset, and/or a robot, for example. The sensor can be used in various 3D sensing or time-of-flight applications, including smart phones, smart glasses, VR headsets, robotic and augmented reality, 3D sensing, or 3D modeling, to name but a few.

Furthermore, a method for a time-of-flight measurement is suggested using an optoelectronic sensor comprising a light projector and a light receiver, wherein the light receiver comprises a number of macro-pixels and the optoelectronic sensor is operable to generate time-of-flight data for the respective macro-pixels corresponding to a number of time windows. The method for a time-of-flight measurement can be carried out with the optoelectronic sensor described herein. Therefore, features and embodiments described herein can be also embodied in the method and vice versa.

According to an embodiment, the method comprises the step of selecting an initial set of integration times that defines an integration time for each time window and macro-pixel.

According to an embodiment of the method, a further step involves acquiring an initial frame of time-of-flight data by collecting time-of-flight data generated from the macro-pixels according to the time windows and integration times defined in the initial set of integration times.

According to an embodiment of the method, a further step involves computing a metric from the initial frame of time-of-flight data, the metric being indicative of a data quality generated by the respective macro-pixels.

According to an embodiment of the method, in an iterative loop the following steps are repeated:
saving the computed metric as a previous metric,
updating the integration times according to an updated set of integration times that defines updated integration times for the time windows and macro-pixels,
acquiring an updated frame of time-of-flight data by collecting time-of-flight data generated from the macro-pixels according to the time windows and integration times defined in the updated set of integration times,
computing the metric from the updated frame of time-of-flight data,
comparing the metric from the updated frame of time-of-flight data with at least one saved previous metric.

For example, the comparing includes that the next integration times are selected to minimize the metric for the next frame. For example, the gradient between the current metric and the previous metric is used to predict the best integration times for the next frame.

The proposed method allows to automatically adapt integration times used by the optoelectronic sensors, e.g. a direct time-of-flight sensor, according to a scene to be observed. This could be done with the iterative process that could continuously adapt the integration time in function also of environmental factors like the ambient light but also to minimize the number of non-detection events or to optimize the SNR. This improves the depth quality and makes the system more resilient to difficult conditions.

In at least one embodiment, the metric depends on a number of non-detections events and/or a signal-to-noise ratio of the time-of-flight data. Both quantities can be derived from the time-of-flight data and provide a convenient means to judge the quality of the data.

In at least one embodiment, the integration times are limited by a targeted total integration time distributed between the time windows.

In at least one embodiment, integrations times are updated according to pre-determined integration tables and/or depending on a computational rule.

In at least one embodiment, the iterative loop further involves estimating an ambient light level. Integration tables are pre-determined for a corresponding ambient light level. Integrations times are updated according to integration tables and as function of ambient light.

In at least one embodiment, the computational rule involves a gradient determined from the calculated metrics.

In at least one embodiment, the iterative loop terminates when a convergence criterion is met, e.g. when the gradient of metric values indicated a local or global minimum or maximum. The minimum or maximum may depend on the definition of the metric. Alternatively, the iterative loop repeats continuously.

In at least one embodiment, a distance resolved image is provided based on the last set of integration times when the iterative has terminated. Alternatively, a distance resolved image is provided for each frame and the integration times are continuously updated for each frame, similarly to an auto-exposure-control algorithm for a color camera.

Further embodiments of the method become apparent to the skilled reader from the aforementioned embodiments of the optoelectronic sensor and of the electronic device, and vice-versa.

### BRIEF DESCRIPTION OF THE DRAWINGS

The following description of figures may further illustrate and explain aspects of the optoelectronic sensor for a time-of-flight measurement, the electronic device and the method for a time-of-flight measurement. Components and parts of the optoelectronic sensor that are functionally identical or have an identical effect are denoted by identical reference symbols. Identical or effectively identical components and parts might be described only with respect to the figures where they occur first. Their description is not necessarily repeated in successive figures.

In the figures:

FIG. 1 shows an example embodiment of an optoelectronic sensor for a time-of-flight measurement,

FIG. 2 shows an example flowchart of a method for a time-of-flight measurement,

FIG. 3 shows an example chart for estimation of the ambient light from a time histogram,

FIG. 4 shows example of time distributions as a function of time windows,

FIG. 5 shows an example chart for relative non-detect events as a function of integration time,

FIG. 6 shows an example comparison of non-detect events with and without adapting integration time of a frame as a function of the scene, and

FIG. 7 shows examples of a scene with and without adapting integration time of a frame as a function of the scene.

### DETAILED DESCRIPTION

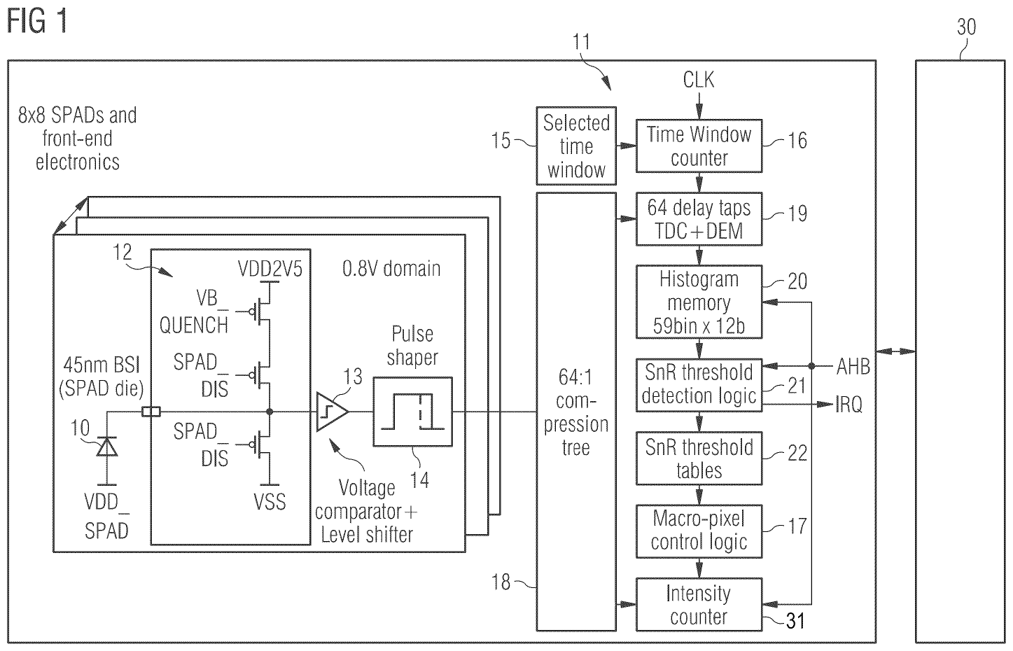

FIG. 1 shows an example embodiment of an optoelectronic sensor for a time-of-flight measurement. The optoelectronic sensor is configured as a direct time-of-flight, or dTOF, sensor. The direct time-of-flight sensor further comprises a light projector and a light receiver, which are arranged in a sensor module. The sensor module encloses the electronic components of the optoelectronic sensor, including the light projector and light receiver. Typically, the light receiver is integrated into an integrated circuit, together with additional electronic circuitry, such as driver circuits (e.g., for the light projector), control circuits, time-to-digital converters (TDCs), histogram memory blocks, an on-chip histogram processing unit, and the like. Typically, but not necessarily, the light projector is not integrated into the integrated circuit but may be electrically connected thereto.

Furthermore, the optoelectronic sensor comprises a processing unit 30 which is operable to conduct steps of a method for a time-of-flight measurement. Details will be discussed further below. Generally, the method may be fully or partially implemented by hardware or by software, e.g. by means of a firmware. The processing unit 30 can be a central processing unit, CPU, e.g. of an electronic device the optoelectronic sensor is connected to, or integrated into the integrated circuit. Alternatively, the processing unit 30 can be a system-on-a-chip, SOC, which is dedicated to process output signals of the optoelectronic sensor, for instance.

Basically, the optoelectronic sensor measures the time-of-flight required for laser pulses to leave the light projector and reflect onto the focal plane array of the light receiver.

The light projector can either be a flood projector that illuminates uniformly the field of view or a dot projector that illuminate the field of view with a structured pattern. The light receiver includes multiple macro-pixels.

For example, the light projector comprises one or more semiconductor lasers (not shown), such as a vertical cavity surface emitting laser (VCSEL), edge emitting semiconductor laser diodes, or an array thereof. VCSELs are an example of resonant-cavity light emitting device. The light emitters comprise semiconductor layers with distributed Bragg reflectors (not shown) which enclose active region layers in between and thus forming a cavity. The VCSELs feature a beam emission of coherent electromagnetic radiation that is perpendicular to a main extension plane of a top surface of the VCSEL. For example, the VCSEL diodes are configured to have an emission wavelength in the infrared, e.g. at 940 nm or 850 nm.

The light receiver comprises one or more semiconductor light detectors 10, e.g. photodiodes, or an array thereof. In an array the semiconductor light detectors are denoted as pixels hereinafter. In this example, the light receiver comprises an array of single-photon avalanche diodes, or SPADs, which can be grouped to form macro-pixels. For example, each macro-pixel hosts 8×8 of individuals SPADs.

FIG. 1 shows an example of an integrated circuit 11. This example serves as one possible implementation to illustrate the type of optoelectronic sensor which can be used to implement the proposed concept. This should not be construed as limiting in any way.

Each SPAD is complemented with a quenching circuit 12. The quenching circuit 12 is coupled to each SPAD and functions to stop the avalanche breakdown process by operably impeding or preventing current flow to the SPAD's such that voltage VDD_SPAD across the SPAD reliably drops below the SPAD's breakdown voltage during each avalanche. The quenching circuit 12 is further coupled to a respective voltage comparator 13 and level shifter. The voltage comparator 13 serves to detect a SPAD detection event and the level shifter translates a detection signal to a digital domain. The level shifted detection signal is then fed into a pulse shaper 14.

The optoelectronic sensor further comprises a receiver logic. The receiver logic can be considered to be a front-end electronics for the macro-pixels. The receiver logic comprises several electronic components, which are involved in control of the macro-pixels, time-of-flight detection and pre-processing of time-of-flight data. The following discussion serves as an example of a receiver logic. Its functionality and electronic components may vary. For example, some functionality may be dedicated to external electronic components of an electronic device, which comprises the optoelectronic sensor, or to the processing unit 30. The receiver logic may, at least in parts, be integrated into the integrated circuit 11, together with the light receiver and/or light projector.

The receiver logic comprises means to select a detection time window. In time-of-flight applications, a detection time window translates into a target range, from which time-of-flight data can be gathered. Acquisition of a frame is based on scanning through multiple, typically overlapping, configurable sub-ranges (named time windows) to cover full target distance range. For example, a target range from 0 to 1.75 m forms a first sub-range and defines a corresponding time window. A selected time window memory 15 comprises a number of time windows. Under control of processing unit 30, a time window can be selected from the time window memory 15. A time window counter 16 (under control of a clock signal) initializes the histogram memory block to create a time histogram for a macro-pixel and a selected time window.

For a given time window, readout may be controlled by a macro-pixel control logic 17. The macro-pixel control logic 17 may be configured such that differently sized macro-pixels are defined. A macro-pixel may be as small as a single pixel or as big as the entire array. Typically, however, the receiver logic is limited in the sense that there may be fewer components than pixels in the array. For example, there may be a dedicated receiver logic for each macro-pixel. Furthermore, there may be even fewer receiver logic and data collection may be executed in a sequential fashion. The following discussion assumes a single macro-pixel for easier representation. The processes shown with respect to said macro-pixel can be applied to the other macro-pixels.

The receiver logic comprises a compression tree block 18. This block receives pulsed signals from the pulse shapers 14 of the light receiver, e.g. the various pixels grouped into a respective macro-pixel. For example, each macro-pixel hosts 8×8 individuals SPADs. The compression tree block 18 compresses the received pulsed signals and provides the compressed signals to a time-to-digital converter block 19. This block comprises one or more time-to-digital converters. The time-to-digital converter block 19 is synchronized with the light projector, e.g. via a driver circuit, to receive a start signal, when a light pulse has been emitted. In turn, detection of a light pulse via a pixel of the array or a macro-pixel issues a stop signal to the time-to-digital converter block 19. The time-to-digital converters generate time-of-flight data, i.e. photons arrival times, depending on the start and stop signals. A histogram memory 20 stores the detected photons arrival time in so-called time histograms. An intensity counter 31 stores a total number of photons.

The receiver logic further comprises a threshold detection logic 21 which is embedded in the receiver logic. This threshold detection logic 21 performs run-time monitoring of the time histogram and target peak detection. The threshold detection logic 21 has access to a threshold table memory 22 to read respective threshold values. For example, the threshold detection logic 21 notifies the processing unit 30, e.g. by means of the firmware, when a peak with signal-to-noise ratio (SNR) larger than a programmed threshold is detected. For a given macro-pixel, the processing unit 30, e.g. by means of the firmware, decides whether the largest amplitude peak in the collected histogram memory has a SNR larger than a configured target SNR from the threshold table memory 22. In that case, acquisition for that macro-pixel is stopped. The processing may be done for all macro-pixels in parallel or sequentially. If SNR does not reach target SNR within the configured integration time, the processing unit 30 stops acquisition and decides to move to a next time window. If for a macro-pixel no peak is detected for all time windows a non-detection event is reported for this macro-pixel.

Alternatively, or in addition, the threshold detection logic 21 may detect whether during an integration time no peak has been detected in a particular time window (non-detect event). For a given macro-pixel, the processing unit 30, e.g. by means of the firmware, decides whether the collected ToF data in the collected histogram memory 20 has any value larger than a configured target SNR from the threshold table memory 22, which would qualify as a peak. In that case, acquisition for that macro-pixel is stopped, and may move to another macro-pixel. If the data does not exceed a target SNR within the configured integration time, the processing unit 30 stops acquisition and decides to move to a next time window.

The optoelectronic sensor supports programming of per window w target signal-to-noise-ratio SNR(w) and a corresponding integration time ITW(w). Each integration time must be configured to be higher than a minimum integration time to reach a target SNR associated to the maximum distance defined for that window, for all macro-pixels. The sum of all per window integration times defines, or is limited by the total integration time per frame.

Depending on the scene conditions, the integration times and SNR targets can be adapted. For example, longer integration times may work better on dark objects or for long range, while shorter integration times may work better for objects with high reflectivity or at a close range. Optionally, it is possible to limit the number of windows to concentrate a desired integration time budget on a smaller number of time windows. This may reduce the range covered by the sensor. An example of a sub-range configuration, including integration times and SNR targets for individual time window can be taken from the following table.

| | Time | Time | Time | Time |
|---|---|---|---|---|
| | window 0 | window 1 | window 2 | window 3 |
| sub-range | 0 to 1.75 | 1.5 to 3.25 | 3 to 4.75 | 4.5 to 6.25 |
| in [m] | | | | |
| signal-to- | SNR(0) | SNR(1) | SNR(2) | SNR(3) |
| noise per | | | | |
| time window | | | | |
| SNR(w) | | | | |
| integration | ITW(0) | ITW(1) | ITW(2) | ITW(3) |
| time per | | | | |
| time window | | | | |
| ITW(w) | | | | |
| in [μs] | | | | |

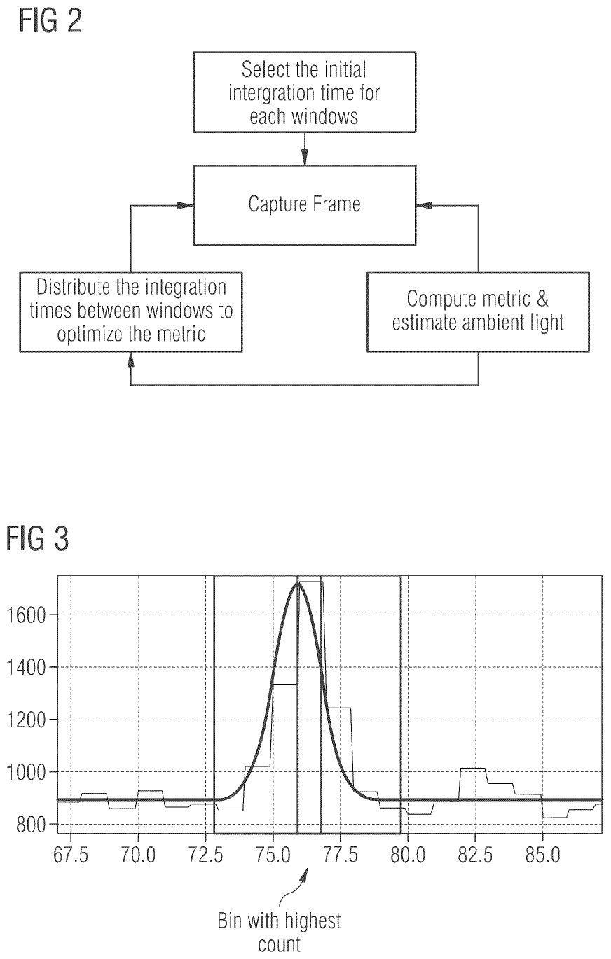

FIG. 2 shows an example flowchart of a method for a time-of-flight measurement. The following steps can be executed by the processing unit 30, e.g. by means of a software or a firmware or by means of hardware, or a combination thereof. The process discussed below can be executed for all macro-pixels in parallel or in a sequential manner. A single macro-pixel is discussed for easier representation only.

In a first step, an initial set of integration times is selected. The initial set of integration times defines an integration time for each time window and macro-pixel of the optoelectronic sensor. The initial integration times can be saved in a sub-range configuration memory, e.g. in a table similar to the one above.

In a next step, an initial frame of time-of-flight data is acquired by collecting time-of-flight data generated from the macro-pixel (or all macro-pixels). Acquisition of a frame is based on scanning through multiple overlapping configurable sub-ranges (or time windows) to cover a full target distance range. The processing unit 30 may read the time windows and integration times defined in the initial set of integration times by accessing the sub-range configuration memory and control the macro-pixel control logic to operate the macro-pixel in a time window and with a respective integration time.

In a next step, a metric is computed from the initial frame of time-of-flight data. The metric is indicative of a data quality generated by the respective macro-pixels. The metric reflects the quality of the captured time-of-flight data and the complexity of the scene and may be computed for each frame. The metric could for example be influenced by the number of non-detection events (no peaks detected, i.e. no peak has been detected for a given macro-pixel) or by the SNR of the detected peaks, for example.

For example, the metric can be the number of non-detection events in the depth map. In this case the metric will be common to all macro-pixels. Another example can be the SNR measured for each macro-pixel or the mean SNR across all macro-pixels. It could also be a combination of the former and the latter.

This step can be complemented with estimating the ambient light. This could be done with an external sensor or by analyzing the time-of-flight data generated by the optoelectronic sensor. Further details will be discussed with respect to FIG. 3.

The following steps are repeated in an iterative loop until an end condition has been reached or run continuously.

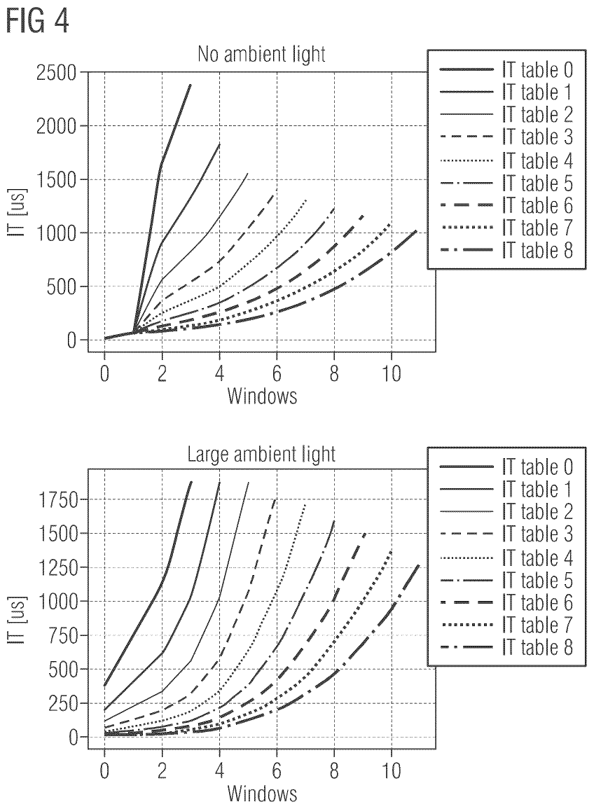

The computed metric is saved, and denoted as a previous metric. Then the integration times are updated according to an updated set of integration times. The updated set of integration times defines updated integration times for the time windows and macro-pixels. The integration times can be updated in a way that optimizes the metric. How the updated integration times are actually set will be discussed further below (see FIG. 4, for example).

In a next step, an updated frame of time-of-flight data is acquired by collecting time-of-flight data generated from the macro-pixels according to the time windows and integration times defined in the updated set of integration times. Then the metric is computed from the updated frame of time-of-flight data.

At this point the (current) metric from the updated frame of time-of-flight data can be compared with at least one saved previous metric. Typically, the iterative loop runs for some steps so that a number of metrics can be collected. The comparison may involve a point-by-point comparison (e.g., with a threshold value), or a gradient, for example. The iterative loop terminates when the comparison meets a convergence criterion. The procedure may continue with another macro-pixel, for example. If all macro-pixels have been processed in the way just described, then the optoelectronic sensor may operate with the last set of integration times. For example, this final stage involves for each macro-pixel a corresponding integration time and time window.

The proposed concept can be repeated automatically or be initialized by user interaction. Furthermore, while the iterative loop one or more time windows may be omitted in order to speed up the loop. For example, if a time window already has a reasonable integration time or if the ToF indicates that no object of interest lies in said time window (i.e., distance range) then said time window may be omitted. The metric provides a means to judge whether one or more time window may safely be omitted.

FIG. 3 shows an example chart for estimation of the ambient light from a time histogram. The graph shows a representation of pixel detection, e.g. SPAD events, as counted by the time histogram as a function of bins. The histogram shows counts associated to arrival time of all SPAD events. The histogram typically shows a peak (here spanning over 3 to 4 bins). The remaining data points typically represent the contribution of ambient light. The intensity counter 31 counts all the SPAD event in the configured integration time, so basically the ratio of number of intensity counts and integration time is a good approximation of ambient light level. More refined approximation can be done by excluding the counts of the bins surrounding the peak.

FIG. 4 shows an example of integration time distributions as a function of time windows. The graphs show integration times IT in us on the y-axis indexed by the time windows on the x-axis. The individual graphs are determined by integration time tables IT table 0, . . . , IT table 8, for example. The integration time tables can be pre-determined and saved in a memory. Alternatively, the integration time tables can be generated during the iterative loop, e.g. according to a computation rule defined in the firmware. The two graphs are further labeled with ambient light level: the upper drawing shows integration time distributions for no or negligible ambient light and the lower drawing shows integration time distributions for high ambient light levels.

The integration time tables can be read by the processing unit 30. These tables define the updated set of integration times, i.e. updated integration times for the time windows and macro-pixels. The integration time tables are labeled IT table 0 to IT table 8 in the drawing. Consider IT table 0 to be the initial set of integration times. As can be seen from the drawing, IT table 0 defines the integration times for respective time windows w=0, . . . , 10.

In this example, the iterative loop starts at IT table 0 to acquire the initial frame of time-of-flight data. Then the metric is computed from the collected time-of-flight data per macro-pixel. Furthermore, an ambient light level is determined, either from the time-of-flight data or by means of a dedicated ambient light sensor, and saved. The updated set of integration times is selected from the integration time tables. For example, IT table 1 is selected. The integration time tables may be indexed and optionally also labeled with an ambient light level. Then selection may proceed iteratively using the index, e.g. by incrementing the index. Furthermore, the updated set of integration times may also be selected to comply with the determined ambient light level, e.g. by means of the ambient light label. This way the iterative process continues with the updated integration times and an updated frame and metric can be acquired or determined.

The integration time tables can be pre-determined. For example, individual integration times for the time windows are limited by a targeted total integration time. This is to say that this total integration time is distributed between the time windows. The total integration time can be distributed between more or less windows depending on the scene conditions. For example, if a large object is present in the scene, it typically has a constant distance over several macro-pixels. Thus, a single range and time window may suffice to map the scene correctly. More complex scene with a number of objects at different distances may ask for more ranges and time windows to map the scene correctly.

For a given time window, there is a maximum integration time given by a maximum expected distance, a maximum ambient light level and a minimum target reflectivity. Integrating longer than the maximum integration time would not yield additional information.

The level of ambient light often plays an important role. It influences the optimal distribution of the integration times across the windows. For example, when no ambient light is present, the system is often subject to blooming or ghosting. To avoid this phenomenon the integration time of one or more time windows need to be capped to a maximal value. When more ambient light is present this constraint can be relaxed. Therefore, multiple integration time tables can be defined for different level of ambient light.

Instead of pre-determined integration time tables updating of integration times may proceed according to computation rule defined in the firmware. For example, the integration times may be increased or decreased by a constant time as the iterative loop continues. Furthermore, generally there may be no targeted total integration time.

For example, in the iterative loop the ambient light in the scene is estimated. This could be done with a dedicated sensor but also directly from the data captured with the dToF sensor. A signal at the position of dots projected with the light projector is compared with a signal which is not illuminated by dots to estimate the ambient light. Using this information, a first set of integration times is chosen and a corresponding first frame is acquired. Then the integration time is changed (increased or decreased) and a second frame is captured. Metrics are computed for both frames (for example number of non-detect events or SNR). The gradient between the two frames is used to set the integration times for a third frame. The gradient constitutes a computation rule in the sense of this disclosure. As the iterative loop proceeds, the gradient between further frames, e.g. the second and third frame, is used to update the integration times for the fourth frame, and so on. The estimated ambient light could also be used to constraint the range of exploration of the iterative approach.

The proposed concept uses multiple time windows with a given integration time for each window. Therefore, the integration times can be optimized for each window independently. For example, if there is a white wall at the position of window 1 and a dark object at the position of window 2, the proposed concept could reduce the integration time of the 1st window while increasing the integration time of the 2nd window.

FIG. 5 shows an example chart for relative non-detect events as a function of integration time. The chart shows percentages of non-detect events for multiple scenes 0_0 to 3_3 as a function of integration time table IT table 1 to 9. It is apparent that the relative number of non-detect events changes depending on which integration time table is used. The metric may reflect this number and a gradient can be used to find a local minimum and associated integration time table. Thus, the gradient on the computed metric between the current and previous frames can be computed and used to select the updated IT table in order to minimize the metric.

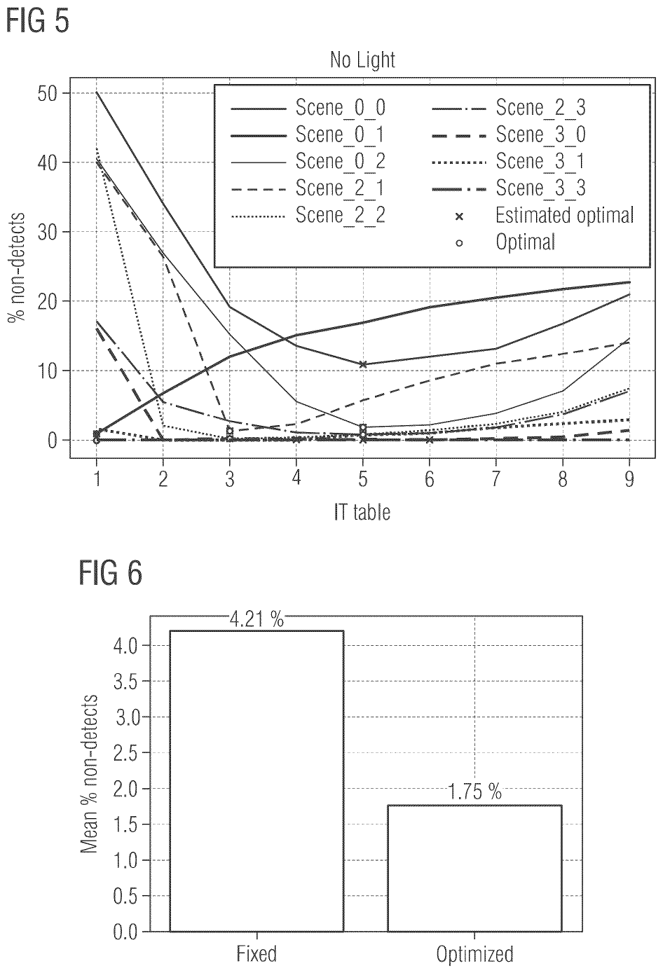

FIG. 6 shows an example comparison of non-detect events with and without adapting integration time of a frame as a function of the scene. This comparison shows how the percentages of non-detect events can be reduced by using the proposed concept for choosing an improved set of integration times.

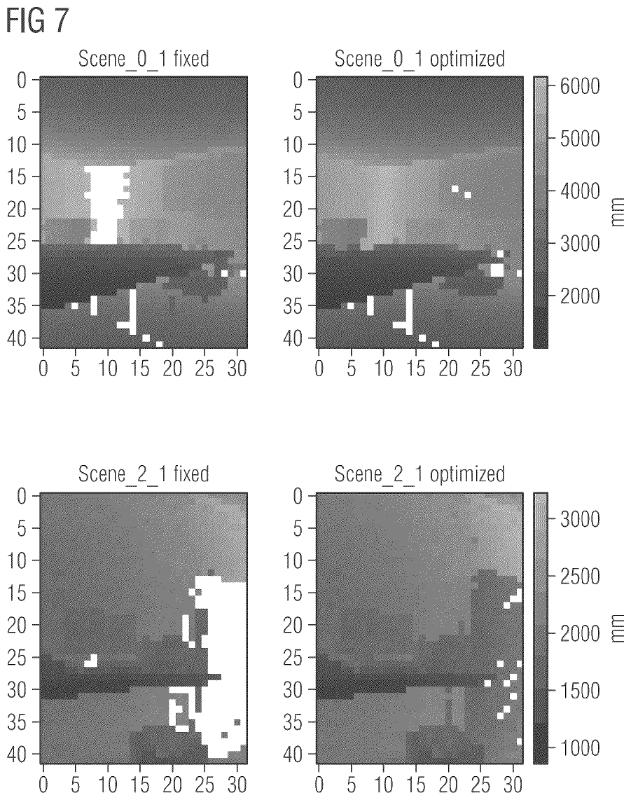

FIG. 7 shows examples of a scene with and without adapting integration time of a frame as a function of the scene. The description above has focused on a particular macro-pixel. However, the ToF data is generated for pixels in the array of the light receiver. Thus, the processing unit 30 ultimately provides a distance resolved image. The drawing comprises two scenes with fixed integration times (on the left) and integration times determined by the proposed concept (on the right). The white areas indicate non-detection events, i.e. during an integration time no peak of a time histogram has been detected in a particular time window. Apparently, these white areas have been considerably improved. Thus, the system will minimize the total integration time for a given scene and guarantee a good depth quality across changing scene.

This application claims priority of the German application DE 102022116500.0, the disclosure content of which is incorporated herein by reference.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

### REFERENCES

10 light detector
11 integrated circuit
12 quenching circuit
13 voltage comparator
14 pulse shaper
15 selected time window memory
16 time window counter
17 macro-pixel control logic
18 compression tree block
19 time-to-digital converter block
20 histogram memory
21 threshold detection logic
22 threshold table memory
30 processing unit
31 intensity counter

1. An optoelectronic sensor for a time-of-flight measurement, comprising:
a light projector and a light receiver, wherein the light receiver comprises a number of macro-pixels,
a receiver logic, which is operable to generate light time-of-flight data for the respective macro-pixels corresponding to a number of time windows, and
a processing unit, which is operable to conduct the following steps:
selecting an initial set of integration times that defines an integration time for each time window and macro-pixel,
acquiring an initial frame of time-of-flight data by collecting time-of-flight data generated from the macro-pixels according to the time windows and integration times defined in the initial set of integration times,
computing a metric from the initial frame of time-of-flight data, the metric being indicative of a data quality generated by the respective macro-pixels, and in an iterative loop repeating the following steps:
saving the computed metric as a previous metric,
updating the integration times according to an updated set of integration times that defines updated integration times for the time windows and macro-pixels,
acquiring an updated frame of time-of-flight data by collecting time-of-flight data generated from the macro-pixels according to the time windows and integration times defined in the updated set of integration times,
computing the metric from the updated frame of time-of-flight data,
comparing the metric from the updated frame of time-of-flight data with at least one saved previous metric.

2. The sensor according to claim 1, wherein:
the iterative loop terminates when the comparison meets a convergence criterion, or
the iterative loop is continuously repeated.

3. The sensor according to claim 1, wherein:
the light projector comprises one or more semiconductor lasers diodes, and/or
the light receiver comprises one or more photodiodes (10).

4. The sensor according to claim 1, wherein the receiver logic is configurable so as to provide programmable time windows and programmable integration time for said time windows.

5. The sensor according to claim 1, wherein the light projector is operable to uniformly illuminate a field-of-view of a scene or is operable to project a structured pattern into said scene.

6. The sensor according to claim 1, further comprising an ambient light detector to detect an ambient light level, and/or wherein, in the iterative loop, the processing unit is operable to update the integration times depending on the ambient light level.

7. The sensor according to claim 1, further comprising a memory to save pre-determined integration tables comprising integration times for time windows, and/or wherein, in the iterative loop, the processing unit is operable to update the integration times depending on the integration tables and/or a computational rule.

8. An electronic device, comprising a host system and at least one optoelectronic sensor according to claim 1, wherein the host system comprises a mobile device, a computer, a vehicle, a 3D camera, a headset, and/or a robot.

9. A method for a time-of-flight measurement using an optoelectronic sensor comprising a light projector and a light receiver, wherein the light receiver comprises a number of macro-pixels and the optoelectronic sensor is operable to generate light time-of-flight data for the respective macro-pixels corresponding to a number of time windows, the method comprising the steps of:
selecting an initial set of integration times that defines an integration time for each time window and macro-pixel,
acquiring an initial frame of time-of-flight data by collecting time-of-flight data generated from the macro-pixels according to the time windows and integration times defined in the initial set of integration times,
computing a metric from the initial frame of time-of-flight data, the metric being indicative of a data quality generated by the respective macro-pixels, and in an iterative loop repeating the following steps:
saving the computed metric as a previous metric,
updating the integration times according to an updated set of integration times that defines updated integration times for the time windows and macro-pixels,
acquiring an updated frame of time-of-flight data by collecting time-of-flight data generated from the macro-pixels according to the time windows and integration times defined in the updated set of integration times,
computing the metric from the updated frame of time-of-flight data,
comparing the metric from the updated frame of time-of-flight data with at least one saved previous metric.

10. The method according to claim 9, wherein the metric depends on a number of non-detection events and/or a signal-to-noise ratio of the time-of-flight data.

11. The method according to claim 9, wherein the integration times are limited by a targeted total integration time distributed between the time windows.

12. The method according to claim 9, wherein integrations times are updated according to pre-determined integration tables and/or depending on a computational rule.

13. The method according to claim 9, wherein
the iterative loop further involves estimating an ambient light level,
integration tables are pre-determined for a corresponding ambient light level, and
integration times are updated according to integration tables and as function of ambient light.

14. The method according to claim 12, wherein the computational rule involves a gradient determined from the calculated metrics.

15. The method according to claim 14, wherein the convergence criterion is met, when the gradient of the metrics indicated a local or global minimum or maximum.

16. The method according to claim 9, wherein a distance resolved image is provided based on the last set of integration times when the iterative has terminated.
